(19) United States
(12) Patent Application Publication
(10) Pub. No.: US 2016/0267463 A1
(43) Pub. Date: Sep. 15, 2016

(54) SYSTEMS, METHOD AND MACHINE-READABLE MEDIUMS FOR FACILITATING THE SALE OF PERSONAL PROPERTY

(71) Applicant: SeatSafe, Inc., Redondo Beach, CA (US)

(72) Inventors: Paul Penney, Manhattan Beach, CA (US); David Raber, Laguna Beach, CA (US)

(21) Appl. No.: 15/065,795

(22) Filed: Mar. 9, 2016

Related U.S. Application Data
(60) Provisional application No. 62/130,453, filed on Mar. 9, 2015.

(51) Int. Cl. G06Q 20/32; H04L 29/08; G06Q 20/36; H04N 7/18

(52) U.S. Cl. CPC G06Q 20/3276; H04N 7/185; H04L 67/02; G06Q 20/3674

(57) ABSTRACT

A computer-implemented process for facilitating the sale of personal property comprising, receiving, at a mobile device, a scan request to scan an identification code of a first personal property, activating a camera of the mobile device to capture a video stream of the identification code, capturing the video stream of the identification code using the camera of the mobile device, analyzing in real-time the video stream for an acceptable image, and providing for the disposition of the first personal property to a third party, wherein the disposition is selected from a group consisting of selling the first personal property, transferring the first personal property, and donating the first personal property.

### CROSS-REFERENCE TO RELATED APPLICATION

This application claims priority to U.S. Provisional Application No. 62/130,453 filed Mar. 9, 2015, entitled “SYSTEMS, METHODS AND MACHINE-READABLE MEDIUMS FOR FACILITATING THE SALE OF PERSONAL PROPERTY,” which is incorporated by reference herein in its entirety.

### FIELD OF THE INVENTION

The field of the invention relates to systems, methods, and machine-readable mediums for facilitating the electronic transfer and/or sale of personal property, and more particularly, to systems, methods, and machine-readable mediums for facilitating the sale/transfer of personal property, such as tickets, passes, permits, etc., between a remote seller/donor and a remote buyer/recipient.

### BRIEF DESCRIPTION OF THE DRAWINGS

FIG. 1 illustrates a block diagram of a system for facilitating the sale of personal property, according to an embodiment of the present disclosure.

FIGS. 2-3 are exemplary diagrams outlining the operation of a system for facilitating the sale of personal property, according to an embodiment of the present disclosure.

FIG. 4 is an exemplary page for a mobile webpage configured to facilitate the sale of tickets for a sporting event, according to an embodiment of the present disclosure.

FIG. 5 is an exemplary page for a mobile device app configured to scan a ticketing barcode, according to an embodiment of the present disclosure.

FIG. 6 is an exemplary page for a mobile device app that may be utilized to sell scanned tickets, according to an embodiment of the present disclosure.

### DETAILED DESCRIPTION

Reference will now be made to certain embodiments, examples of which are illustrated in the accompanying drawings. While the invention will be described in conjunction with these embodiments, it will be understood that these embodiments are not intended to limit the scope of the invention. On the contrary, the invention is intended to cover alternatives, modifications, and equivalents, which may be included within the spirit and scope of the invention as defined by the appended claims. As such, the description of the embodiments that follow are for purposes of illustration and not imitation.

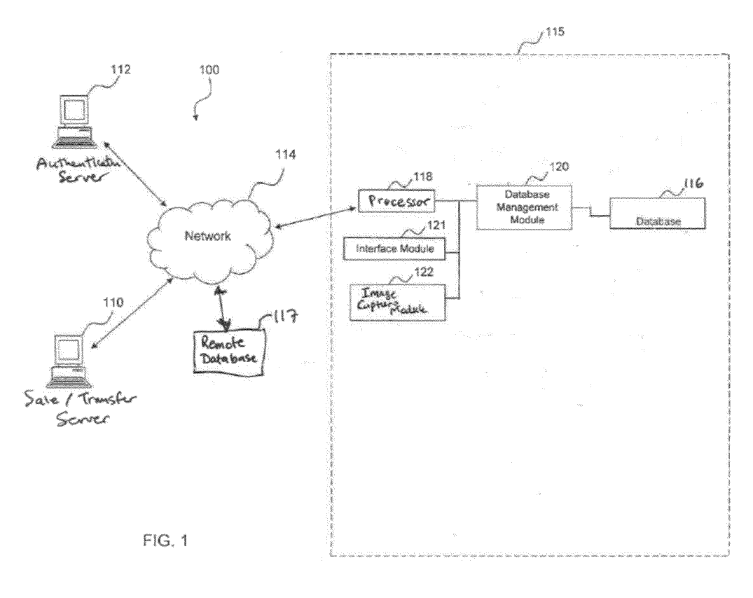

FIG. 1 illustrates a block diagram of a system 100 for facilitating the sale of, according to a non-limiting embodiment of the present disclosure. A mobile device 115, for example, a smartphone app or software, may be accessible to an authentication server 112 and a sale/transfer server 110 via a network 114.

In one embodiment, the mobile device 115 may include a processor 118, one or more modules and one or more databases. The mobile device 115 may include a database management module 120, an interface module 121, and an image capture module 122. As used herein, the term module refers to logic embodied in hardware or firmware, or to a collection of software instructions, possibly having entry and exit points, written in a programming language, such as, for example, C++. A software module may be compiled and linked into an executable program, or installed in a dynamic link library, or may be written in an interpretive language. It will be appreciated that software modules may be callable from other modules, and/or may be invoked in response to detected events or interrupts. Software instructions may be embedded in firmware. It will be further appreciated that hardware modules may be comprised of connected logic units, such as gates and flip-flops, and/or may be comprised of programmable units, such as programmable gate arrays. The modules described herein are preferably implemented as software modules, but could be represented in hardware or firmware. As can be appreciated, the software module(s) may be downloaded on a mobile device from an app store.

In one embodiment, each module is provided as a modular code object, where the code objects typically interact through a set of standardized function calls. In one embodiment, the code objects are written in a suitable software language such as C++, but the code objects can be written in any low level or high level language. In one embodiment, the code modules may be implemented to run on mobile devices with operating software, such as Windows, Android or iOS. Artisans of skill in the art will recognize that any number of implementations, including code implementations directly to hardware, are also possible.

The database management module 120 may be used to provide database management functions for one or more databases. As is well known, database categories above can be combined, further divided or cross-correlated, and any combination of databases and the like can be provided from within the processor 118. In one embodiment, any portion of the databases can be provided externally from the mobile device 115, either locally on the processor 118, or remotely over a network, such as remote database 117. The external data from the remote database 117 can be provided in any standardized form which the processor 118 can understand. For example, the remote database 117 at a provider can advantageously store end-user data, such as, for example, name, user identification, and personal property identification information, and the like, and the end-user data blocks may be transformed by the database management module 120 into a function call format which the code modules can understand.

As can be appreciated, the databases may be used to store, arrange and retrieve data. The databases may be storage devices such as machine-readable mediums, which may be any mechanism that provides (i.e. stores and/or transmits) information in a form readable by a processor. For example, the machine-readable medium may be a read only memory (ROM), a random access memory (RAM), a cache, a hard disk drive, a floppy disk drive, a magnetic disk storage media, an optical storage media, a flash memory device or any other device capable of storing information. Additionally, machine-readable medium may also comprise computer storage media and communication media. Machine-readable medium includes volatile and non-volatile, removable and non-removable media implemented in any method or technology for storage of information such as computer-readable instructions, data structures, program modules or other data. Machine-readable medium also includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by a computer.

The interface module 121 may be operatively associated with a number of different modules. For example, the interface module 121 may be operatively associated with the image capture module 122 to allow users to capture images, such as for example bar codes, using the mobile device 115. In one embodiment, the image capture module 122 may be used to capture images using a mobile device's camera. For example, image capture module 122 may be programmed to activate the mobile device's camera in video mode to capture images continuously and stops when an acceptable image, for example, a well-focused, well-lit image is captured, as provided by the MiSnap! technology of Mitek Technologies, Inc.

In one embodiment, the processor 118 is responsive to the receipt of a captured image by the image capture module 122, and transmits the captured image via Network 114 to the authentication server 112 to determine if the captured image that identifies the personal property is genuine. If the authentication server 112 confirms that the personal property is genuine, the processor 118 may prompt the interface module 121 to display one or more options for disposing or transferring of the personal property. For example, the user may be prompted to choose between selling the personal property, transferring the personal property, or donating the personal property. Responsive to the user's selection, the processor 118 communicates the user selection to a sale/transfer server 110, for example, a ticket server, for disposition of the personal property in accordance with the user's selection.

As is understood by a person skilled in the art, the code modules may be compiled on one or more processors 118, to perform a set of functional calls. In one embodiment, the one or more processors may be configured, programmed and/or provided code instructions from one or more modules to receive an individual's sign up information, verify the individual's membership for accessing the interface module 121, capture an image, for example, a bar code or the like, determine the authenticity of the personal property, provide at least one option for transferring the personal property to a remote recipient, facilitate the transfer of the personal property. Moreover, skilled artisans would understand that the functions performed by the authentication server 112 and the sale/transfer server 110 may be combined or compiled on one ticket server, or distributed over a plurality of servers.

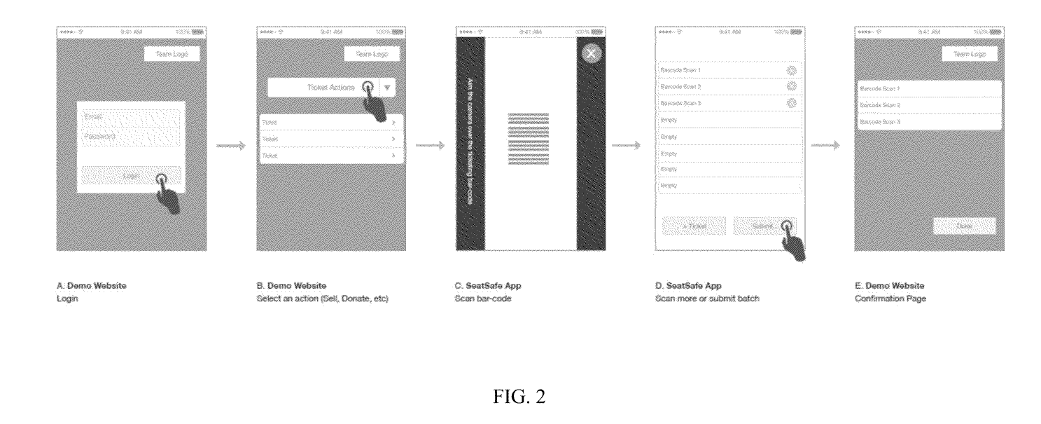

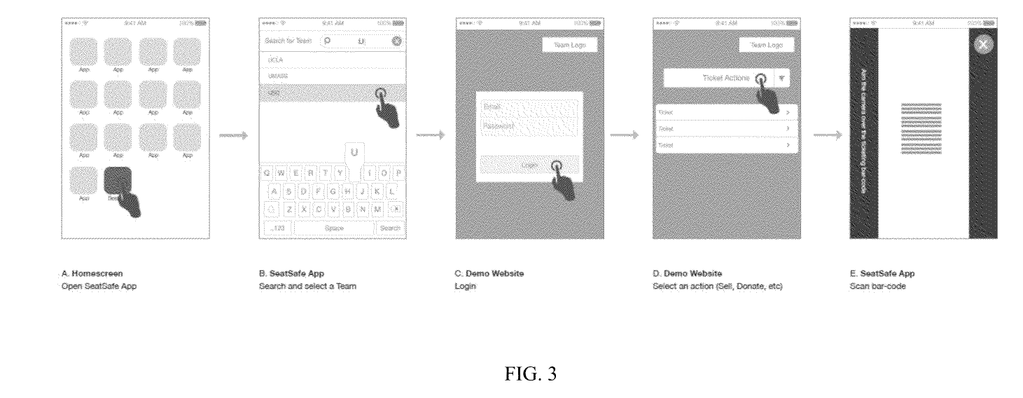

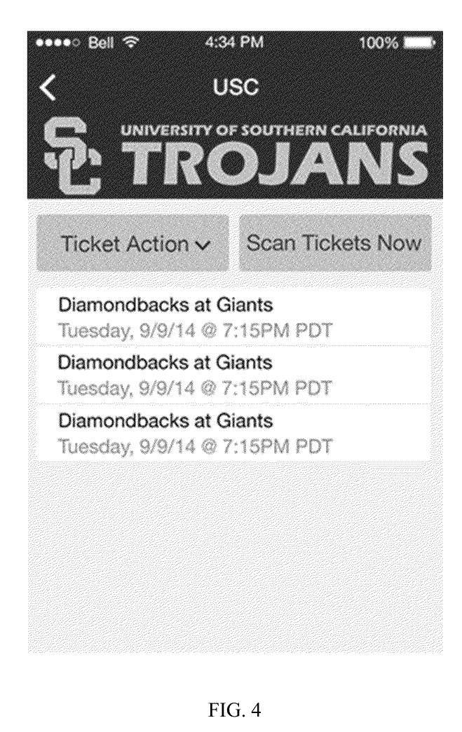

FIGS. 2-3 are exemplary diagrams outlining the operation of a system for facilitating the sale of personal property, according to an embodiment of the present disclosure. As can be appreciated, the personal property may be tickets to sporting events, concerts and the like. FIG. 4 is an exemplary page for a mobile webpage configured to facilitate the sale of tickets for a sporting event, according to an embodiment of the present disclosure. In one embodiment, the user may visit a team's website and log into his/her ticket account on the team's site via the mobile device 115. The user may be prompted with the option to scan the personal property or personal property identification code, for example, prompted to select “Scan Tickets Now” button on their smartphone or other mobile device. The team's ticket server host may add the “Scan Tickets Now” button to their page to enable the activation of the interface module 121. The activation of the interface module 121 allows for the capturing of an image of the personal property identification code using mobile app technology residing on the mobile device database 116. In one embodiment, the interface module 121 activates the image capture module 122 to capture a video stream of the identification code and analyze in real time for an acceptable image.

In one embodiment, the user selection of the “Scan Tickets Now” button may activate the transmittal of an industry-standard instruction to the mobile device to start the interface module 121 app via a standard hyperlink call. If the app is not yet installed on the mobile device 115, the mobile device 115 may follow a standard process for when an app is not installed. For example, the user may be prompted to install the app. Once the interface module 121 app is installed, the workflow may resume. If the user declines to install the app, then the workflow terminates.

In one embodiment, the mobile web page from the ticket server may also transmit to interface module 115 a context key that uniquely identifies a particular user. For example, this context key may be a random GUID. In another embodiment, the mobile webpage may also prompt the user to select to choose between selling the personal property, transferring the personal property, or donating the personal property. If an action is selected by the user before the interface module 121 app is activated, then the interface module 121 uses that selection as a default action. However, as can be appreciated by those skilled in the art, the user may have the option to change the selection upon activation of the interface module 121.

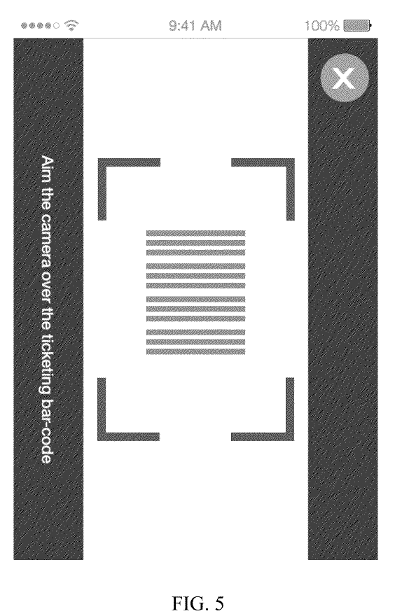

FIG. 5 is an exemplary page for a mobile device app configured to scan a ticketing barcode, according to an embodiment of the present disclosure. The interface module 121 may prompt the activation of the mobile device's camera, and may display a template to assist in capturing an acceptable image of a ticket's identification code, for example, bar code. As noted above, the user interface 115 may use image capture technology, such as MiSnap! technology by Mitek Technologies Inc., that activates the mobile device's camera into video mode to capture images continuously, then stops when a well-focused, well lit image is received.

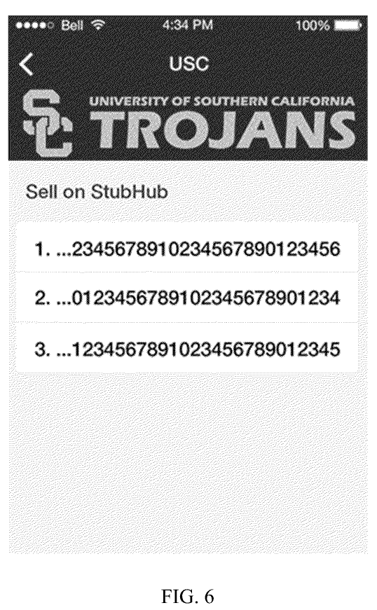

In one embodiment, after a ticket barcode is successfully captured, it may be placed into a “cart” on the mobile device 115, as shown in FIG. 6. A “cart” summary may be presented, via the interface module 121, after each ticket is captured. In one embodiment, the user may be prompted with an option to either scan more tickets (bar codes) or continue with the transaction. As can be appreciated, the interface module 121 communicates with the authentication server 112 (i.e. ticket server) to confirm the tickets corresponding to the scanned bar codes are genuine.

Artisans would appreciate that the interface module 121 may be branded for each sports team, artist or venue. Branding information, such as colors and logos, as well as the options that the team supports may be stored in database 117 that the interface module 121 may accesses in real-time.

As previously noted, the user may be prompted to select on option for disposition of the personal property. For example, the user may be prompted to select from offering the ticket for sale, donate, or transfer. In one embodiment, not all participating teams, artists and venues would offer all three choices, and as such, not all three choices may be available for all tickets. As can be appreciated, this may be tailored to the participating team, artist, or venue, and is implemented by the ticket server.

As shown in the exemplary page in FIG. 6, a “Sell on StubHub” option may be displayed. Each team may designate any number of options for the interface module 121 to handle. If only one option is enabled, then the user is not given a choice of the other options. If two or more options are selected, then the user may see a drop-down menu where, in this example, it displays “Sell on StubHub.” The options may also be stored on the database 117 that the interface module 121 has access to.

If the user pushes the button to “Scan More Tickets,” they may be returned to the scan screen to scan additional personal property identification code, i.e. bar code of a ticket. If the user selects “Continue,” the workflow continues. When the user selects the option to continue the transaction, the interface module 121 may transfer the user to a mobile webform on ticket server specifically built to receive the image captured information. This webpage may receive a list of identification codes (i.e. barcodes) scanned along with the context id for the transaction, and the selected ticket action. At this time, the interface module 121 operation is done with the transaction, and may close down.

Skilled artisans would understand that the ticket server (sale/transfer server 110) for the team resumes its workflow at this point, processing the request from the user in the same way it would had the ticket numbers been typed in, or selected from a list of owned tickets. The sale/transfer server 110 may be programmed to notify the user of any error conditions (i.e. invalid ticket, selected action not available for those ticket, etc). As can be appreciated, the ticket server may also collect and process any additional information necessary, such as, but not limited to, charity name for donations, recipient for transfer, asking price for offer-for-sale, etc.

While certain exemplary embodiments have been described and shown in the accompanying drawings, it is to be understood that such embodiments are merely illustrative of and not restrictive on the broad invention, and that the inventions are not be limited to the specific constructions and arrangements shown and described, since various other changes, combinations, omissions, modifications and substitutions, in addition to those set forth in the above paragraphs, are possible. For examples any combination which performs a functionally analogous task as server is understood within the scope of the specification to be included within the definition of the server. Likewise, artisans understand that for the purpose of the instant disclosure, the server may include any number of serially linked units performing these functions within the scope of this invention.

As can be envisioned by a person skilled in the art, the systems, methods and machine-readable mediums may be used to provide cheaper software, and/or electronics embodying the software, by offsetting the price reduction with revenue generated from sponsored advertisements. Electronics, such as cell phones, cameras, media players, computers, and machinery employing electronics or software, such as vehicles, motorbikes, and the like, may be sold at a reduced price, or even distributed at no cost to the consumer while maintaining profitability by obtaining revenue through sponsored advertisements and other content information.

Those skilled in the art will appreciate that various adaptations and modifications of the just described preferred embodiments may be configured without departing from the scope and spirit of the invention. Therefore, it is to be understood that, within the scope of the appended claims, the invention may be practiced other than as specifically described herein.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action. Similarly, each physical element disclosed should be understood to encompass a disclosure of the action which that physical element facilitates.

It should be understood that various modifications and similar arrangements are included within the spirit and scope of the claims, the scope of which should be accorded the broadest interpretation so as to encompass all such modifications and similar structures. The present disclosure includes any and all embodiments of the following claims.

1. A computer-implemented method of facilitating the sale of personal property, comprising:
receiving, at a mobile device, a scan request to scan an identification code of a first personal property;
activating a camera of the mobile device to capture a video stream of the identification code;
capturing the video stream of the identification code using the camera of the mobile device;
analyzing in real-time the video stream for an acceptable image; and
providing for the disposition of the first personal property to a third party, wherein the disposition is selected from a group consisting of selling the first personal property, transferring the first personal property, and donating the first personal property.

2. The computer-implemented method of claim 1, further comprising prompting to capture an image of the identification code of a second personal property.

3. The computer-implemented method of claim 1, wherein the scan request is received, via a network, from a mobile webpage server.

4. The computer-implemented method of claim 3, further comprising transmitting the acceptable image, via the network, to the mobile webpage server to verify authenticity and provide for disposition of the personal property.

5. A system for facilitating the sale of personal property, comprising:
a database for storing data associated with identification code for at least one personal property;
a camera for capturing a video stream;
a processor programmed to:
receive a scan request to scan an identification code of the at least one personal property;
activate the camera to capture a video stream of the identification code;
capture the video stream of the identification code using the camera;
analyze in real-time the video stream for an acceptable image; and
provide for the disposition of the at least one personal property to a third party, wherein the disposition is selected from a group consisting of selling the at least one personal property, transferring the at least one personal property, and donating the at least one personal property.
